(19) United States
(12) Patent Application Publication
(10) Pub. No.: US 2010/0243614 A1
(43) Pub. Date: Sep. 30, 2010

(54) METHOD OF REPAIRING HOLES USING CONDUCTIVE HEAT RESISTANCE WELDING

(75) Inventors: Billie W. Bunting, Colchester, CT (US); James J. Moor, New Hartford, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORPORATION, Hartford, CT (US)

(21) Appl. No.: 12/413,947

(22) Filed: Mar. 30, 2009

(51) Int. Cl. B23K 11/00; B23K 11/36; B23K 31/02

(52) U.S. Cl. 219/117.1; 228/119; 219/119

(57) ABSTRACT

A method of repairing a hole in a work piece includes mechanically constraining donor plates against a work piece. Constraint plates keep donor plates flush against the work piece during conductive heat resistance welding. By constraining the donor plates, the molten mixture produced by conductive heat resistance welding cannot escape the hole and a weldment substantially free of voids is formed.

### BACKGROUND

The present disclosure relates to a method of repairing holes in a work piece. More particularly, the present disclosure relates to an improved method of repairing holes in a work piece using conductive heat resistance welding.

An undesirable defect or hole located in a metallic work piece may be repaired by welding. Welding is a known process for joining materials by causing coalescence. For example, a damaged work piece and adjacent filler material are heated to form a molten pool in the area of the defect. The molten pool is then cooled to solidification thereby forming a weldment.

It is known to fill a defect or hole in the work piece with a consumable filler plug and sandwich the work piece between sacrificial donor plates to create a stack. The stack is further sandwiched between one or more layers of electrode backing plates, which are then brought into contact with welding electrodes. An electrical current is passed between the electrodes, thereby resistively heating the electrode backing plates and conductively heating the sacrificial donor plates, work piece, and consumable filler plug. The donor plates, work piece, and filler plug coalesce into a liquid pool within the hole, which is then cooled to form a weldment.

### SUMMARY

A method of repairing a hole in a work piece includes placing a plug within the hole of the work piece and covering opposing top and bottom open end portions of the hole, as well as a portion of adjacent work piece, with a top donor sheet and a bottom donor sheet, respectively. A portion of the top donor sheet that is located above the hole is covered with at least one top electrode backing plate and a portion of the bottom donor sheet that is located beneath the hole is covered with at least one bottom electrode backing plate. The top electrode backing plate is contacted with a top electrode and the bottom electrode backing plate is contacted with a bottom electrode. Electrical current is transmitted between the top electrode and the bottom electrode to resistively heat the top and the bottom electrode backing plates and conductively heat a portion of the top and the bottom donor sheets, the plug, and the work piece to form a molten mixture that at least partially fills the hole. The top donor sheet and the bottom donor sheet are constrained with constraint plates that force the donor sheets against the work piece to contain the molten mixture within the hole.

Another method of repairing a hole in a work piece includes preparing a stack that includes at least one top electrode backing plate, a top donor sheet, a work piece having a hole therein and a plug located within the hole, a bottom donor sheet, and at least one bottom electrode backing plate. The electrode backing plates and donor sheets all lie above or beneath the hole in the work piece. The top and the bottom donor sheets are constrained against the work piece. The top and the bottom electrode backing plates are contacted with electrodes. The stack is heated by electrical current to melt the top and the bottom donor sheets, the plug, and the work piece thereby forming a weldment.

A welding stack for performing repairs includes a work piece having a top surface, a bottom surface, and a hole extending from the top surface to the bottom surface. A plug is located within the hole. A top donor plate is in contact with the top surface of the work piece and a bottom donor plate is in contact with the bottom surface of the work piece, so that the hole is sandwiched between the top donor plate and the bottom donor plate. At least one top constraint plate is in contact with the top donor plate and at least one bottom constraint plate is in contact with the bottom donor plate. The constraint plates force the donor plates against the work piece to facilitate preventing expulsion of molten material from the hole during conductive heat resistance welding.

### BRIEF DESCRIPTION OF THE DRAWINGS

FIG. 1 is a perspective view of a work piece having defects.

FIG. 2 is a cross-sectional view of the work piece and defect taken on line 2-2 of FIG. 1.

FIG. 3 is a cross-sectional view of a welding stack according to the prior art.

FIG. 4 is a cross-sectional view of the welding stack from FIG. 3 after conductive heat resistance welding showing porosity, expulsion of molten material, and bent donor plates.

FIG. 5A is a top view of a welding stack in accordance with an exemplary embodiment of the present disclosure.

FIG. 5B is a cross-sectional view of the welding stack taken on line 5B-5B of FIG. 5A.

FIG. 6A is a top view of an alternative embodiment of a welding stack in accordance with another exemplary embodiment of the present disclosure.

FIG. 6B is a cross-sectional view of the welding stack taken on line 6B-6B of FIG. 6A.

### DETAILED DESCRIPTION

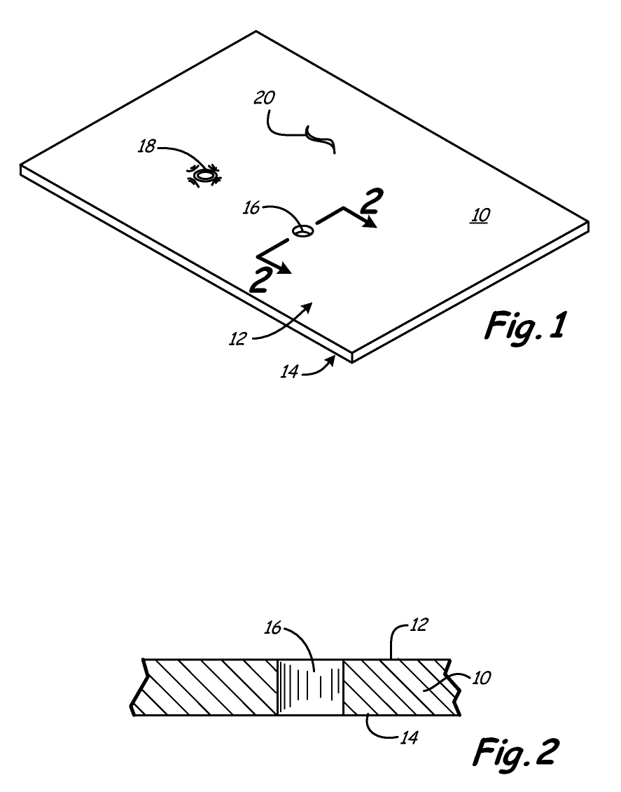

FIG. 1 is a perspective view of work piece 10 having top side 12, bottom side 14, and defects 16, 18, and 20. Work piece 10 may include any metal, such as but not limited to, aluminum and aluminum alloys. Top side 12 and bottom side 14 are substantially planar and parallel to one another. Defect or hole 16 is substantially cylindrical and extends through work piece 10 from top side 12 to bottom side 14, such that work piece 10 defines opposing top and bottom open end portions of hole 16. Defects 18 and 20 are dents or other imperfections located on top side 12 of work piece 10.

FIG. 2 is a cross-sectional view of work piece 10 having top side 12, bottom side 14, and hole 16 taken on line 2-2 of FIG. 1. Work piece 10 may be an aluminum flange for use in the aircraft industry, and hole 16 may be formed from insertion of a bolt into work piece 10. If hole 16 is undesirable it can be filed by conductive heat resistance welding.

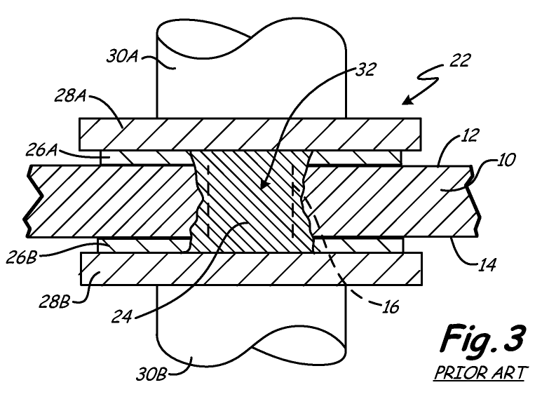

FIG. 3 is a cross-sectional view of prior art welding stack 22 using conductive heat resistance welding as known in the art. Welding stack 22 includes work piece 10, top side 12, bottom side 14, hole 16, plug 24, top and bottom donor sheets 26, top and bottom electrode backing plates 28, top and bottom electrodes 30, and molten pool 32. Welding stack 22 having work piece 10 is constructed to at least partially fill hole 16 by conductive heat resistance welding.

To form prior art welding stack 22, work piece 10 having hole 16 is sandwiched between donor sheets 26A, 26B, electrode backing plates 28A, 28B, and electrodes 30A, 30B. Plug 24 is substantially cylindrical and smaller than hole 16 so that plug 24 fits inside of hole 16. Plug 24 is consumed by the welding process and is formed of the same material as work piece 10. A top end of hole 16, as well as top side 12 of work piece 10 adjacent hole 16, are covered by top donor sheet 26A. Similarly, a bottom end of hole 16, as well as bottom side 14 of work piece 10 adjacent hole 16, are covered by bottom donor sheet 26B. Donor sheets 26A, 26B are consumable by the welding process and are formed of the same material as work piece 10. Although donor sheets 26A, 26B are shown singularly, there can be additional layers of donor sheets in succession. A top side of top donor sheet 26A is covered by top electrode backing plate 28A and a bottom side of bottom donor sheet 26B is covered by bottom electrode backing plate 28B. Thus, electrode backing plates 28A, 28B sandwich donor sheets 26A, 26B that sandwich work piece 10 to create stack 22. Electrode backing plates 28A, 28B include substantially circular plates and are located in vertical alignment or centrally above and beneath hole 16. Electrode backing plates 28A, 28B, can be formed of steel or any other material having a higher melting temperature than the melting temperature of donor sheets 26A, 26B. Although electrode backing plates 28A, 28B are shown singularly, there can be additional layers of electrode backing plates in succession. A top side of top electrode backing plate 28A is in contact with top electrode 30A and a bottom side of bottom electrode backing plate 28B is in contact with bottom electrode 30B. Molten pool is located in a center of welding stack 22 and encompasses the area of hole 16 as well as a potion of work piece 10, and donor sheets 26A, 26B.

Electrical current is transmitted through an approximate center of welding stack 22 by electrodes 30A, 20B. Electrode backing plates 28A, 28B are resistively heated by electrodes 30A, 30B and donor sheets 26A, 26B are conductively heated by electrode backing plates 28A, 28B. The conductive heating of donor sheets 26A, 26B also conductively heat plug 24 and work piece 10 adjacent hole 16 so that donor sheets 26A, 26B, plug 24, and work piece 10 form molten pool 32 in the area of hole 16. When current to electrodes 30A, 30B is turned off or electrodes 30A, 30B are withdrawn from stack 22, molten pool 32 cools and solidifies into a weldment.

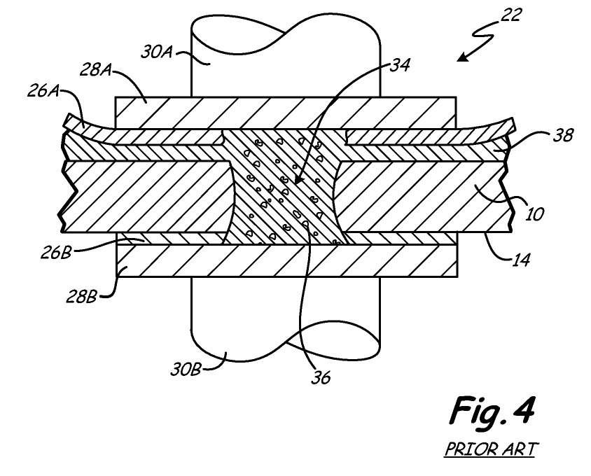

FIG. 4 is a cross-sectional view of the welding stack from FIG. 3 after conductive heat resistance welding showing porosity, expulsion of molten material, and bent donor plates. Depicted in FIG. 4 are welding stack 22 including work piece 10, top side 12, bottom side 14, hole 16, top and bottom donor sheets 26, top and bottom electrode backing plates 28, and top and bottom electrodes 30, weldment 34, voids 36, and expulsed material 38. As described above, donor sheets 26A, 26B, plug 24, and work piece 10 adjacent hole 16, are all conductively heated to form molten pool 32. When cooled, molten pool 32 forms weldment 34 in the area where hole 16 was located on work piece 10.

Located within, and scattered throughout weldment 34, are voids 36. Most materials, including aluminum and aluminum alloys, shrink during solidification causing cracking, porosity, or voids 36 in weldment 34. Voids are highly undesirable as they reduce the strength and other mechanical properties of both weldment 34 and the overall work piece 10. The area of work piece 10 surrounding weldment 34 is deformed or “sucked in”. Furthermore, donor plates 26 are deformed and curving away from weldment 34. The deformation of work piece 10, weldment 34, and/or donor plates 26 is undesirable as it indicates the presence of unsatisfactory weldment 34. Expulsed material 38 was part of molten pool 32 that escaped upwardly and outwardly from hole 16 during the welding process and hardened to a bottom surface or a top surface of top donor sheet 26A and/or top electrode backing plate 28A. Expulsed material 38 is undesirable as it is a sign of a non-uniform weld. Expulsed material 38 often reduces the volume of molten pool 32 leaving voids 36 within hole 16 thereby creating a satisfactory weldment 34. There is a need to improve the quality and consistency of weldments 34 formed using prior art stack 22 with conductive heat resistance welding.

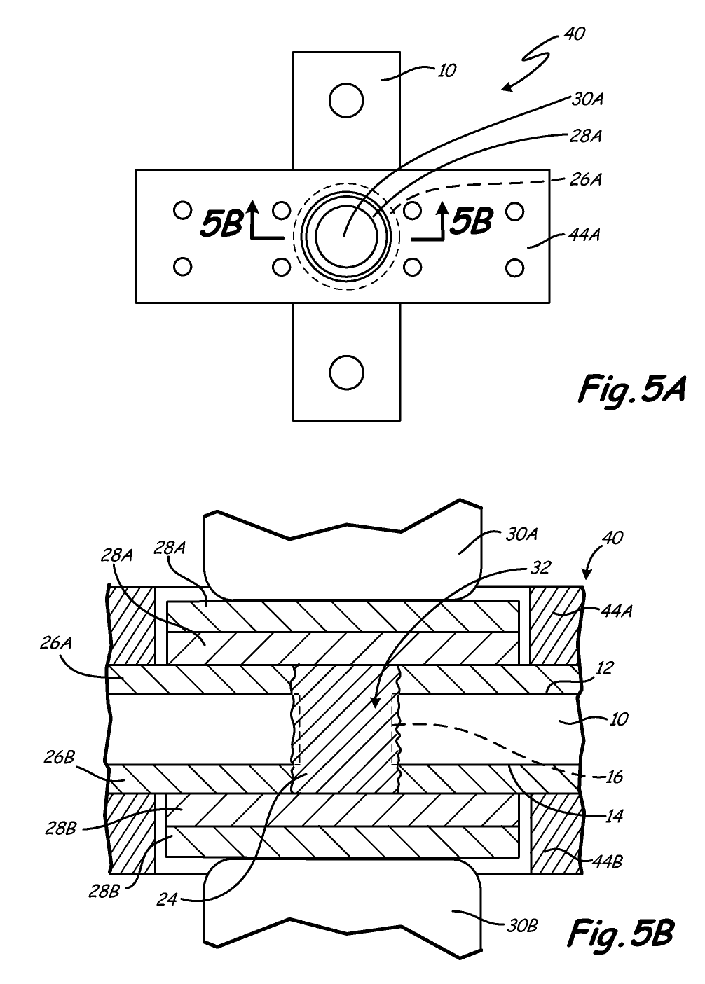

FIG. 5A is a top view and FIG. 5B is a cross-sectional view of welding stack 40 in accordance with an exemplary embodiment of the present disclosure. Welding stack 40 includes work piece 10, top side 12, bottom side 14, hole 16, plug 24, donor sheets 26A, 26B, electrode backing plates 28A, 28B, electrodes 30A, 30B, molten pool 32, and constraint plates 44A, 44B. The components of welding stack 40 are arranged similarly to the components of prior art welding stack 22 described above with reference to FIG. 3. A difference between prior art welding stack 22 and welding stack 40 in accordance with the present disclosure is the presence of constraint plates 44A, 44B. Constraint plates 44A, 44B are substantially planar, can include a space or hole for circular electrode backing plates 28A, 28B, and are spaced laterally or horizontally from electrode backing plates 28A, 28B. Top constraint plate 44A is in contact with, and substantially covers top donor sheet 26A. Similarly, bottom constraint plate 44B is in contact with, and substantially covers bottom donor sheet 26B. Constraints plates 44A, 44B are secured to welding stack 40 by clamps or bolts or the like.

Constraint plates 44A, 44B provide mechanical restraint to donor sheets 26A, 26B, respectively, by forcing donor sheets 26A, 26B centrally toward work piece 10. By constraining donor sheets 26 toward work piece 10, hydrostatic pressure within hole 16 is maintained and molten pool 32 is not expulsed during the welding process. While electrode backing plates 28A, 28B provide some force to donor sheets 26A, 26B located in substantial vertical alignment directly above hole 16, constraint plates 44A, 44B provide substantial force to donor sheets 26A, 26B peripherally or at a location spaced laterally or horizontally away from hole 16. In the depicted embodiments, a space or recess for electrode backing plates 28A, 28B and electrodes 30A, 30B is cut out of constraint plates 44A, 44B. Constraint plates 44A, 44B facilitate preventing cracks and/or deformation of donor sheets 26A, 26B during welding. By keeping donor sheets 26A, 26B stiff and pressed against work piece 10, molten pool 32 has no path to escape hole 16 and therefore, the resulting weldment is substantially free of voids.

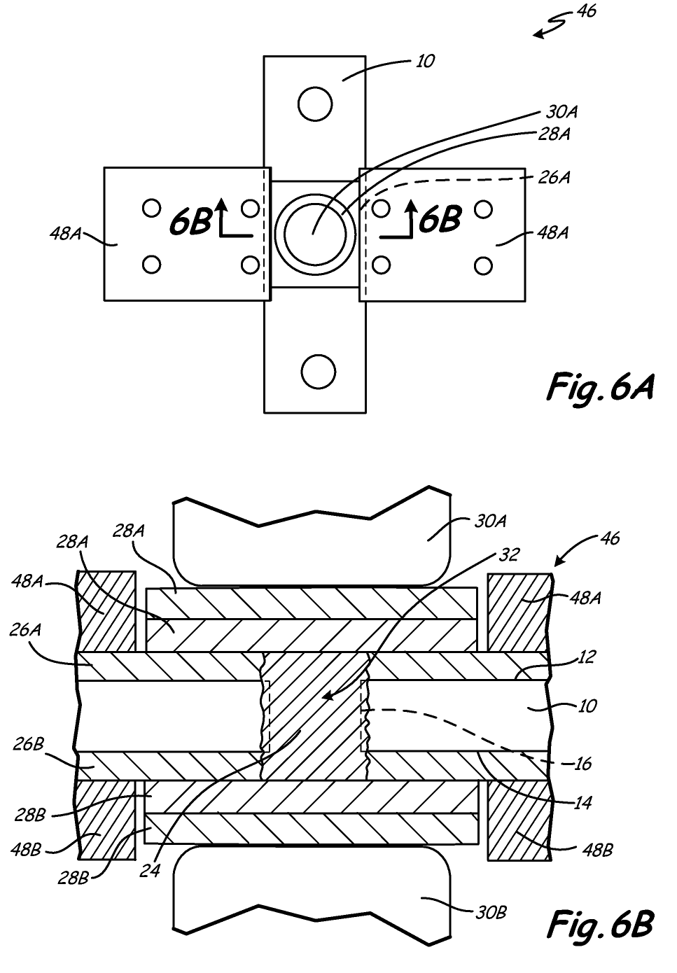

FIG. 6A is a top view and FIG. 6B is a cross-sectional view of an alternative embodiment of welding stack 46 in accordance with the present disclosure. Welding stack 46 includes work piece 10, top side 12, bottom side 14, hole 16, plug 24, donor sheets 26A, 26B, electrode backing plates 28A, 28B, electrodes 30A, 30B, molten pool 32, and constraint plates 48A, 48B. The components of welding stack 46 are arranged similarly to the components of welding stack 40 described above with reference to FIGS. 5A & 5B. A difference between welding stack 40 and welding stack 46 is constraint plates 48A, 48B. While welding stack 40 includes a single top constraint plate 44A and a single bottom constraint plate 44B both having cut-outs, welding stack 46 includes two top constraint plates 48A and two bottom constraint plates 48B. Constraint plates 48A, 48B are located on either side of, and spaced apart from electrode backing plates 28A, 28B and electrodes 30A, 30B, respectively. Top constraint plates 48A are in contact with, and substantially cover top donor sheet 26A. Similarly, bottom constraint plates 48B are in contact with, and substantially cover bottom donor sheet 26B. Constraints plates 48A and 48B are secured to welding stack 46 by clamps or bolts or the like.

As described above, constraint plates 48A, 48B provide mechanical restraint to donor sheets 26A, 26B by forcing donor sheets 26A, 26B toward work piece 10. The functionality of constraint plates 48A, 48B is similar to constraint plates 44A, 44B. By keeping donor sheets 26A, 26B pressed against work piece 10, molten pool 32 has no path to escape hole 16 and therefore, the resulting weldment is substantially free of voids. After conductive heat resistance welding is applied to welding stack 40 or 46, any unconsumed portion of donor sheets 26A, 26B, electrode backing plates 28A, 28B, electrodes 30A, 30B, constraint plates 44A, 44B, 48A, 48B are removed from work piece 10. If any excess, extraneous, or undesirable material remains attached to work piece 10 after welding, it can be removed so that the mechanical properties of the repaired work piece 10 similar to the mechanical properties of original work piece.

Vertical, horizontal, above, beneath, top and bottom have been used through the specification to help define relative directions. Although the present disclosure has been described with reference to exemplary embodiments, workers skilled in the art will recognize that changes may be made in form and detail without departing from the spirit and scope of the disclosure.

1. A method of repairing a hole in a work piece, the method comprising:
placing a plug within the hole of the work piece;
covering opposing top and bottom open end portions of the hole, as well as a portion of adjacent work piece, with a top donor sheet and a bottom donor sheet, respectively;
covering a portion of the top donor sheet that is located above the hole with at least one top electrode backing plate and covering a portion of the bottom donor sheet that is located beneath the hole with at least one bottom electrode backing plate;
contacting the top electrode backing plate with a top electrode and contacting the bottom electrode backing plate with a bottom electrode;
transmitting electrical current between the top electrode and the bottom electrode to resistively heat the top and the bottom electrode backing plates and conductively heat a portion of the top and the bottom donor sheets, the plug, and the work piece to form a molten mixture that at least partially fills the hole; and
constraining the top donor sheet and the bottom donor sheet with constraint plates that force the donor sheets against the work piece to contain the molten mixture within the hole.

2. The method of claim 1, further comprising:
cooling the molten mixture to form a weldment.

3. The method of claim 2, further comprising:
removing the top electrode, the bottom electrode, the top electrode backing plate, the bottom electrode backing plate, any unconsumed portion of the top donor sheet, and any unconsumed portion of the bottom donor sheet from the work piece.

4. The method of claim 3, further comprising:
removing any extraneous material from the work piece.

5. The method of claim 2, wherein the weldment formed is substantially free of pores, cracks and deformation.

6. The method of claim 1, wherein the work piece is substantially planar and the hole is substantially cylindrical.

7. The method of claim 1, wherein the electrode backing plates have melting temperatures higher than the melting temperatures of the donor sheets.

8. The method of claim 1, wherein the plug and the work piece comprise the same metallic material.

9. The method of claim 8, wherein the metallic material is an aluminum composition.

10. The method of claim 1, wherein the constraint plates are secured to the donor sheets.

11. A method of repairing a hole in a work piece, the method comprising the step of:
preparing a stack including:
at least one top electrode backing plate;
a top donor sheet;
a work piece having a hole therein and a plug located within the hole;
a bottom donor sheet; and
at least one bottom electrode backing plate, wherein the electrode backing plates and donor sheets all lie above or beneath the hole in the work piece; and
constraining the top and the bottom donor sheets against the work piece;
contacting the top and the bottom electrode backing plates with electrodes; and
heating the stack by electrical current to melt the top and the bottom donor sheets, the plug, and the work piece thereby forming a weldment.

12. The method of claim 11, wherein a top constraint plate and a bottom constraint plate are secured to the top and bottom donor sheets at a location spaced apart from the hole in the work piece perform the step of constraining the top and the bottom donor sheets against the work piece.

13. The method of claim 12, wherein constraining the top and the bottom donor sheets against the work piece produces hydrostatic pressure sufficient to form a weldment free of porosity and expulsion.

14. The method of claim 13, further comprising:
cooling the stack;
removing the electrode backing plates and any unconsumed portion of the donor sheets to expose the repaired work piece; and
removing excess material from a surface of the work piece.

15. A welding stack for performing repairs, the stack comprising:
a work piece having a top surface, a bottom surface, and a hole extending from the top surface to the bottom surface;
a plug located within the hole;
a top donor plate in contact with the top surface of the work piece and a bottom donor plate in contact with the bottom surface of the work piece, such that the hole is sandwiched between the top donor plate and the bottom donor plate;
at least one top constraint plate in contact with the top donor plate and at least one bottom constraint plate in contact with the bottom donor plate, wherein the constraint plates force the donor plates against the work piece to facilitate preventing expulsion of molten material from the hole during conductive heat resistance welding.

16. The welding stack of claim 15, further comprising:
at least one top electrode backing plate in contact with the top donor plate and at least one bottom electrode backing plate in contact with the bottom donor plate.

17. The welding stack of claim 16, further comprising:
a top electrode in contact with the top electrode backing plate and a bottom electrode in contact with the bottom electrode backing plate for providing electrical current to the stack.

18. The welding stack of claim 15, wherein the constraint plates are spaced laterally away from the hole in the work piece.

19. The welding stack of claim 15, wherein the plug, the donor sheets, and the work piece all comprise aluminum alloys.

20. The welding stack of claim 15, wherein the work piece is substantially planar and the hole is substantially cylindrical.
